(19) United States
(12) Patent Application Publication
(10) Pub. No.: US 2023/0134415 A1
(43) Pub. Date: May 4, 2023

(54) FUEL CELL

(71) Applicant: EH GROUP ENGINEERING AG, Nyon (CH)

(72) Inventors: Alexandre Chainho, Sombacour (FR); Mardit Matian, Prangins (CH)

(21) Appl. No.: 17/906,910

(22) PCT Filed: Mar. 26, 2020
(86) PCT No.: PCT/EP2020/058584

§ 371 Date: Sep. 21, 2022

(51) Int. Cl. H01M 8/1004; H01M 8/0267; H01M 8/2483; H01M 8/242

(52) U.S. Cl. CPC H01M 8/1004; H01M 8/0267; H01M 8/2483; H01M 8/242

(57) ABSTRACT

A fuel cell including at least one membrane, at least one anode electrode layer, at least one cathode electrode layer, at least two gas diffusion layers and at least two flow field structures. The at least one membrane is arranged between one anode electrode layer and one cathode electrode layer, forming a membrane electrode assembly and defining an active area. One gas diffusion layer is arranged adjacent to each electrode layer. One flow field structure is arranged adjacent to each gas diffusion layer. Each flow field structure includes at least three fuel manifolds, at least three oxidant manifolds and at least three coolant manifolds. The fuel cell includes at least two active areas and in that at least one fuel manifold, at least one oxidant manifold and at least one coolant manifold is arranged between the at least two active areas.

### TECHNICAL FIELD OF THE INVENTION

The current invention relates to a fuel cell, in particular to a fuel cell module.

### DESCRIPTION OF THE RELATED ART

Fuel cells are electrochemical devices that convert energy of hydrogen into electricity that have attracted quite a lot of interest in the recent years as a cleaner source of energy and alternative to fossil fuels. There are several type of fuel cells under development that are mainly categorised based on material and operating temperature. Polymer Electrolyte Membrane Fuel Cell (PEMFC) due to its high-power density and compactness is one of the best candidates for not only mobile and automotive but also for stationary applications.

A single cell in a PEMFC is consists of a thin electrolyte and a catalyst layer on the anode side and a catalyst layer on the cathode side, where the assembly is so called a Membrane Electrode Assembly (MEA). Fuel (normally hydrogen) passes through one surface of the membrane and oxidant (normally air) on the other side where electro-chemical reaction occurs to produce electricity and water as by-product. With the current technologies, a current density up to 2 to 3 [A/cm²] and a volume power density of 4 to 5 [W/m³] can be achieved. In order to increase these values and to improve the performance of fuel cells, it is necessary to work towards dimensional compactness. Main parameters that play important roles in the operation of a fuel cell stack are pressure drop across a fuel cell stack, oxygen utilisation (depletion of oxygen), phase change and water management, and membrane dehydration. Effect of these parameters become more trivial when stack operates under dynamic and load modulating conditions. For example, such fuel cells are known from WO 2019/207811, US 2019/0221868 and US 2019/0214654.

### SUMMARY OF THE INVENTION

In the current invention, a problem to be solved is the increase of the current and volume power density. With the current invention, values of 6 to 7 [kW/L] and beyond are possible. Additionally, the manufacturing method of fuel cells according to the invention are simplified and improved significantly.

This problem is solved by a fuel cell with the features of claim 1. Further embodiments of the fuel cell are defined by the features of further claims.

A fuel cell according to the invention comprising at least one membrane, at least one anode electrode layer, at least one cathode electrode layer, at least two gas diffusion layers and at least two flow field structures. The at least one membrane is arranged between one anode electrode layer and one cathode electrode layer, forming a membrane electrode assembly and defining an active area. One gas diffusion layer is arranged adjacent to each electrode layer and one flow field structure is arranged adjacent to each gas diffusion layer. Each flow field structure comprises at least three fuel manifolds, at least three oxidant manifolds and at least three coolant manifolds. The fuel cell comprises at least two active areas and wherein at least one fuel manifold, at least one oxidant manifold and at least one coolant manifold is arranged between the at least two active areas.

With such a design, feeding of the media is split into numerous branches that enter and leave a small section of the active area so called ‘segment’ independent from the other sections. In other words, active area of a single cell has been split into several smaller active areas where fluids enter and leave at specific locations on the cell. Fluids can be gases such as air, hydrogen, humidified or not (gases in general) or liquids (such as DI-water, anti-freeze, etc.).

By referring to the fuel cell theory, the “reversable open circuit voltage” of a hydrogen fuel cell is defined by the “Nernst” equation, where voltage of a cell is in direct correlation with partial pressure of oxygen. This means, utilisation and reduction of oxygen inside a cell leads to lower cell voltage. In a gas channel, starting from the inlet towards the outlet, by consuming oxygen, the voltage of the cell drops, which reduces the average cell voltage. However, the current approach assists in overcoming this issue by introducing fresh fluid between the segmented active areas. Thus, increasing voltage of the cell at each entry point and therefore increasing the average cell voltage.

Another advantage of current invention is that due to the segmentation of the active areas of the cell, the gas channels are shorter and therefore the pressure drop across each segment reduces significantly compared to any conventional approach. Hence, with a fuel cell according to the invention, running a stack by using a blower instead of a compressor is possible. In other words, a fuel cell system with less parasitic loads can be provided.

Another advantage of the segmentation of the cell is that thermal management of the cell becomes easier as temperature variation will be more uniform and reproduced within the active area due to the small segments. It gives more flexibility on external dimensioning of a cell without affecting performance.

The concept can be explained in more detail by comparing to a start-of-the-art design. An automotive stack with active area of 300 [cm²] (a common size) with a length of 30 [cm] and a width of 10 [cm] and a gas channel length of 30 [cm] is considered. In a nominal operating condition, a pressure drop of around 20-50 [KPa] and temperature variation between 5-8° C. is expected between the inlet and outlet of the channels and hence of the cell. Furthermore, oxidant and fuel utilisation and water management will be limited to the geometry and length of the channels.

By segmenting the cell, the gas channel can be split into several sections with smaller channel lengths like 5 [cm], resulting in a smaller pressure drop (linear relation i.e. five times less), a smaller temperature difference between the inlet and outlet i.e. better durability, easier water management and oxidant utilisation. Furthermore, the cell can have different dimensions such as 30×10 [cm²] or 20×15 [cm²] or any other configuration without influencing the performance.

In one embodiment, at least one of each of the three manifolds is an inlet manifold and at least two of them are outlet manifolds. Alternatively, at least two of the three manifolds are inlet manifolds and at least one of them is an outlet manifold.

In one embodiment, the number of outlet manifolds is twice the number of inlet manifolds. Alternatively, the number of inlet manifolds is twice the number of outlet manifolds.

In one embodiment, the cross-sectional size of all manifolds is identical. Alternatively, the cross-sectional size of at least one of the manifolds differs from the size of the other manifolds.

In one embodiment, the cross-sectional shape of all manifolds is identical. Alternatively, the cross-sectional shape of at least one of the manifolds differs from the shape of the other manifolds.

In one embodiment, the shape of the manifolds is one of the group comprising angled, rectangular, square, oval and round. However, any shape could be possible.

In one embodiment, for each of the three manifolds, the total cross-sectional area of all inlet manifolds equals the total cross-sectional area of all outlet manifolds.

In one embodiment, for each of the three manifolds, the total cross-sectional area of all inlet manifolds is larger than the total cross-sectional area of all outlet manifolds. Alternatively, for each of the three manifolds, the total cross-sectional area of all inlet manifolds is smaller than the total cross-sectional area of all outlet manifolds.

In one embodiment, the total cross-sectional area of the fuel manifolds equals the total cross-sectional area of the oxidant manifolds and/or the total cross-sectional area of the coolant manifolds.

In one embodiment, the total cross-sectional area of the fuel manifolds is larger than the total cross-sectional area of the oxidant manifolds and/or the total cross-sectional area of the coolant manifolds. Alternatively, the total cross-sectional area of the fuel manifolds is smaller than the total cross-sectional area of the oxidant manifolds and/or the total cross-sectional area of the coolant manifolds.

In one embodiment, the fuel cell comprises a pattern of manifolds that repeats itself in at least a first direction. Alternatively, the pattern repeats itself in the first direction and in a second direction, perpendicular to the first direction.

In one embodiment, the distance between two repeating patterns is identical to the distance between two neighbouring manifolds within the patterns. Alternatively, the distance between two repeating patterns is bigger than the distance between two neighbouring manifolds within the patterns.

In one embodiment, the fuel cell comprises at least two gaskets, wherein one gasket is arranged adjacent to each flow field structure and wherein each gasket comprises the same number of manifolds as the flow field structures at the same positions.

In one embodiment, the fuel cell comprises at least one sub-gasket, wherein the sub-gasket covers at least border areas of the membrane on both sides. Alternatively, the sub-gasket covers at least border areas of the membrane and the electrode layers on both sides.

In one embodiment, the sub-gasket extends laterally over the border areas of the membrane and the electrode layers.

In one embodiment, the fuel cell comprises several membrane electrode assemblies, several gas diffusion layers and several flow field structures that are aligned with each other and are forming a stack.

In one embodiment, the fuel cell comprises two current collector plates and two backing plates, wherein one collector plate is arranged adjacent to each flow field structure and wherein one backing plate is arranged adjacent to each collector plate.

In one embodiment, clamping elements are bracing the two backing plates.

The features of the before-mentioned embodiments of the fuel cell can be used in any combination, unless they contradict each other.

### BRIEF DESCRIPTION OF THE DRAWINGS

Embodiments of the current invention are described in more detail in the following with reference to the figures. These are for illustrative purposes only and are not to be construed as limiting. It shows

FIG. 1 a fuel cell according to the prior art;

FIG. 2 a diagram of the behaviour of the fuel cell of FIG. 1;

FIG. 3 a cross-section of the fuel cell of FIG. 1 along line X-X;

FIG. 4 a schematic top view of a first embodiment of a fuel cell according to the invention;

FIG. 5 a diagram of the behaviour of the fuel cell of FIG. 4;

FIG. 6 a cross-section of the fuel cell of FIG. 4 along line Y-Y;

FIG. 7 a schematic top view of a second embodiment of a fuel cell according to the invention;

FIG. 8 a schematic top view of a third embodiment of a fuel cell according to the invention;

FIG. 9 a partial schematic top view of a fourth embodiment of a fuel cell according to the invention;

FIG. 10 a partial schematic top view of a fifth embodiment of a fuel cell according to the invention;

FIG. 11 a partial schematic top view of a sixth embodiment of a fuel cell according to the invention;

FIG. 12A a schematic cross-section of a first embodiment of a sub-gasket; and

FIG. 12B a schematic cross-section of a second embodiment of a sub-gasket.

### DETAILED DESCRIPTION OF THE INVENTION

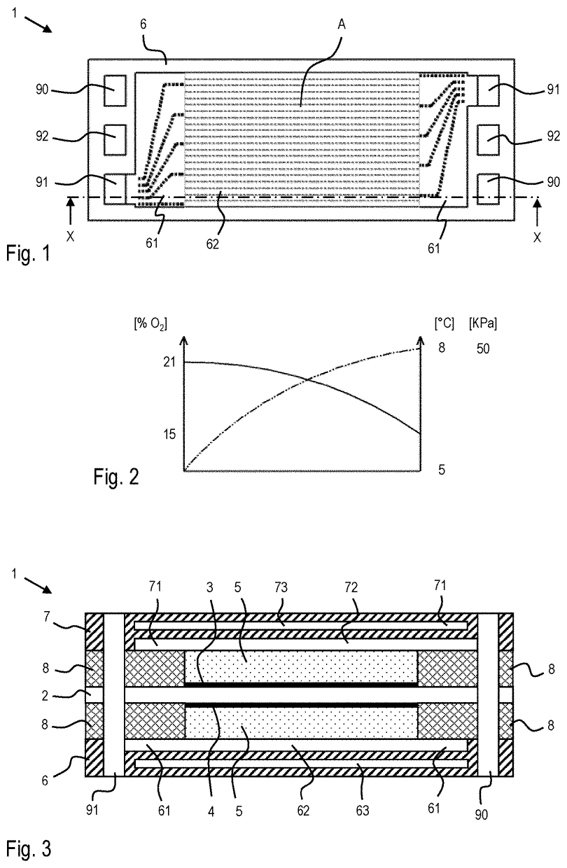

FIG. 1 shows a fuel cell 1 according to the prior art with a conventional membrane electrode assembly (MEA) with one active area A and gas inlet/outlet manifolds 90,91,92. The active area A of the cell is located in its middle, with gas inlet/outlet manifolds 90,91,92 around its outside edges. There is a distribution channel 61 between the active area A and the inlet manifolds 90,91,92 for distributing gases uniformly and there is a collecting channel between the active area A and the outlet manifolds 90,91,92 for collecting gases, which are mainly integrated on the bi-polar plate. The shown MEA and bi-polar plate have a rectangular shape. The active area A comprises flow field channels 62 that extend from the inlet side to the outlet side of the cell.

FIG. 2 shows a diagram of the behaviour of the fuel cell of FIG. 1. Important parameters that influence the performance of a fuel cell are pressure drop, humidity, temperature and fuel/oxidant utilisation. Air, normally 21% oxygen and 79% nitrogen, is humidified before entering the cell. In the figure, Y-axis represents percentage of partial pressure of oxygen, and the X-axis represents length of the gas channel with X(O₂) 21% at the inlet and X(O₂) around 15% at the outlet. The X(O₂) at the outlet varies based on the cell performance, current drawn from the cell and stoichiometry of air entering the cell. For example, at high current densities (+2.0 [A/cm²]) depletion of oxygen increases and with low stoichiometries performance of the cell drops towards the end of the channel. The second curve represents the pressure drop and the temperature increase across the channel. The longer or narrower the channel, the larger the pressure drop. Hence, more parasitic loads for the compressor or blower at the system level. In a nominal operating condition, a pressure drop of around 20-50 [KPa] and the temperature increases between 5-8° C. between the inlet and outlet of the channels and hence of the cell is expected. For mobile applications, 300 [cm²] is a common size for an active area, with a width of 10 [cm] and channel length of 30 [cm]. The cross-sectional dimensions of a channel based on stamping technology is limited to somewhat around 0.2 to 0.3 [cm]. The overall performance of the cell will drop due to larger pressure drop, high gas velocities, water management and oxidant/fuel utilisation.

FIG. 3 shows a cross-section of the fuel cell of FIG. 1 along line X-X. The fuel cell 1 comprises a membrane 2 that is sandwiched between an anode electrode layer 3 and a cathode electrode layer 4. Gas diffusion layers 5 are arranged adjacent to each of the electrode layers 3,4. Flow field structures 6,7 are arranged adjacent to each of the gas diffusion layers 5. Each flow field structure 6,7 comprises connection channels 61,71, flow field channels 62,72, cooling channels 63,73 and manifolds 90,91. Gaskets 8 are arranged between the flow field structures 6,7 for laterally sealing the fuel cell. The manifolds 90,91 extend through the flow field structures 6,7 and the gaskets 8.

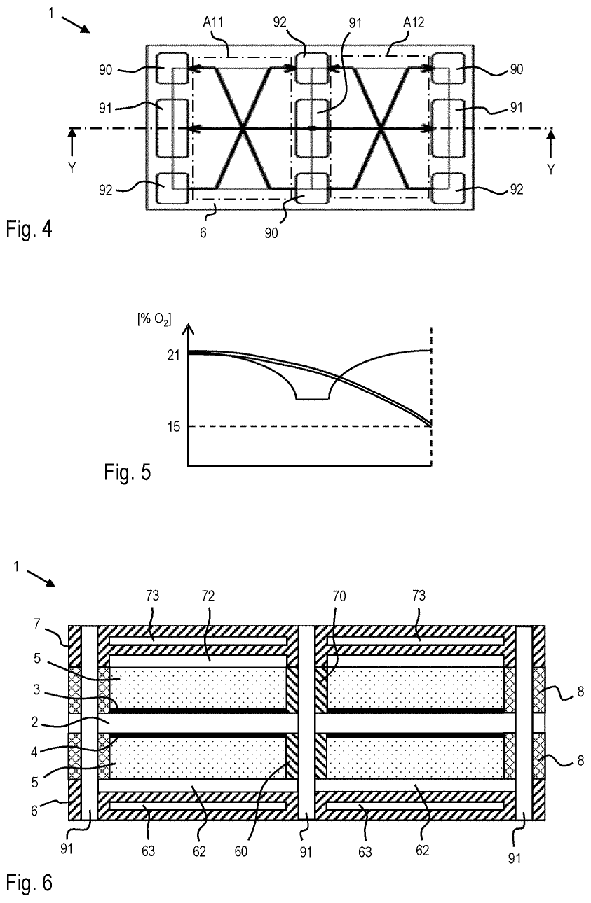

FIG. 4 shows a schematic top view of a first embodiment of a fuel cell 1 according to the invention. It comprises two segments, each with an active area A11,A12. Manifolds 90,91,92 are arranged on the sides of the cell and between the two neighbouring active areas A11,A12. The fuel flows from the fuel manifold 90 between the two active areas A11,A12 through each of the two active areas and to the fuel manifolds 90 on either side of the two active areas. The oxidant flows from one oxidant manifold 91 between the two active areas to the two oxidant manifolds 91 on either side of the two active areas. The coolant flows from the two lateral coolant manifolds 92 to the middle coolant manifold 92. In the depicted embodiment, all coolant manifolds 92 are aligned with each other and the middle fuel manifold 90 is aligned with the two lateral oxidant manifolds 91 and the middle oxidant manifold 91 is aligned with the two lateral fuel manifolds 90. In an alternative embodiment, all or none of the same kind of manifolds can be aligned with each other.

FIG. 5 shows a diagram of the behaviour of the fuel cell of FIG. 4, i.e. the effect of the design of the fuel cell according to the invention on the oxidant/fuel utilisation. The double-lined curve represents cathode inlet/outlet and oxygen utilisation inside a single straight gas channel of a conventional fuel cell. The solid lines represent cathode inlet/outlet and oxygen utilisation inside the gas channel of a fuel cell according to the invention. Apart from the principle gas inlet and outlet, there is one additional point of entry and exit, which reduces the pressure drop, increases the oxygen concentration and therefore increases the performance of the fuel cell. Additionally, the temperature variation is reduced, and the gas distribution is enhanced. In this example, fresh gas is supplied between the two active areas. In comparison to a conventional fuel cell, the length of the active are is divided in half. With a conventional length of 30 [cm], the depicted length corresponds to around 15 [cm]. The number and length of segments can vary based on geometry, dimensions and other requirements. For instance, a gas channel length 30 [cm] with one inlet and outlet can be split into a few smaller channels like 5 [cm] each.

FIG. 6 shows a cross-section of the fuel cell of FIG. 4 along line Y-Y. The fuel cell 1 has essentially the same design as the one from FIG. 3. Additionally, spacers 60,70 are arranged in the middle of the cell between the membrane 2 and the corresponding flow field structure 6,7. In this cross-section, an oxidant manifold 91 extends through the membrane 2, the spacers 6,7 and the flow field structures 6,7. In the same manner, the fuel manifold and the cooling manifold extend through these components.

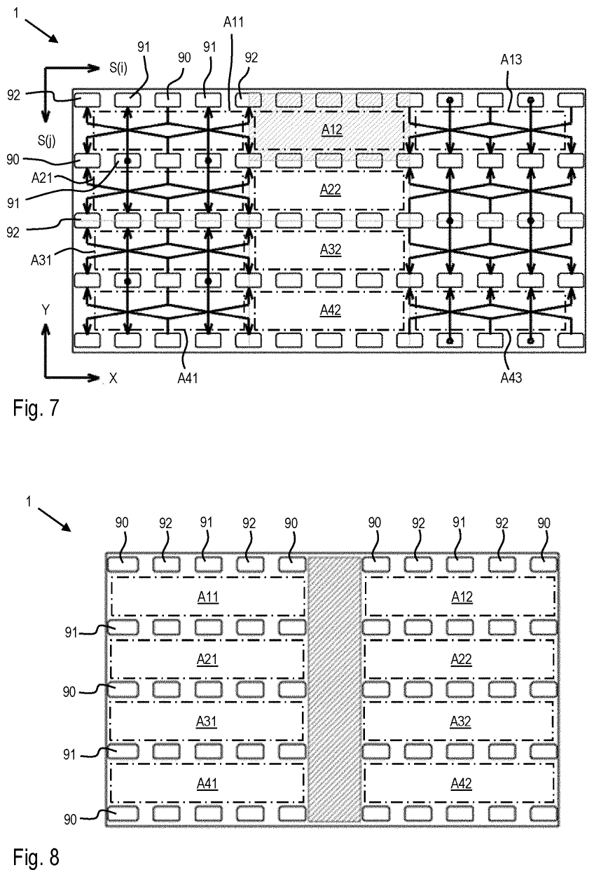

FIG. 7 shows a schematic top view of a second embodiment of a fuel cell according to the invention. The cell is split into several segments. The identification of the segments is done as follows: S(ij) is used for referencing, where (i) represents the horizontal location of each segment in the (X) direction and (j) vertical location in the (Y) direction. For instance, S(12) would be the second segment on the first line. The dimension and number of segments in a cell is not limited to what has been shown in the figure (i.e. 12 segments). The numbers of segments on horizontal and vertical directions can vary independently from each other without affecting operation and performance of the other segments. With this, the cell geometry can be easily modified from square to rectangular or substantial rectangular shape where the ratio between the horizontal and vertical sides are very large. The ratio of the number of segments in the X-direction to the number of segments in the Y-direction may varies between 0.001 to 1000 and more precisely between 0.1 and 10. Each segment S(ij) comprising a corresponding active area A(ij). The shown embodiment with mixed flow configuration in different regions of the cell is just for explanatory reason. It is preferable to keep the flow configuration similar or identical in all the segments in order to maintain consistent performance over the entire cell. Segments S(11) to S(41) have a counter-flow configuration, i.e. the fuel gas and the oxidant gas flow in the opposite direction. The oxidant, in this case air, enters these segments from two separate oxidant manifold 91 and exits these segments through two separate oxidant manifolds 91. The fuel, in this case hydrogen, enters these segments from one single fuel manifold 90 and exits through two separate fuel manifolds 90. In a similar manner, the coolant enters these segments from one single coolant manifolds 92 and exits through two separate coolant manifolds 92. In the depicted embodiment, Segments S(13) to S(43) have a co-flow configuration, i.e. the fuel gas and the oxidant gas flow in the same direction. The manifolds 90,91,92 between two adjacent segments supply gas to both these segments.

FIG. 8 shows a schematic top view of a third embodiment of a fuel cell according to the invention. It comprises a space between two columns of segments. There are different reasons to have such spaces, like passage for gas manifolds or current collectors. From production point of view, the space in the middle can be made from sub-gasket, special resin or the catalyst coated membrane (CCM) can be left on its own.

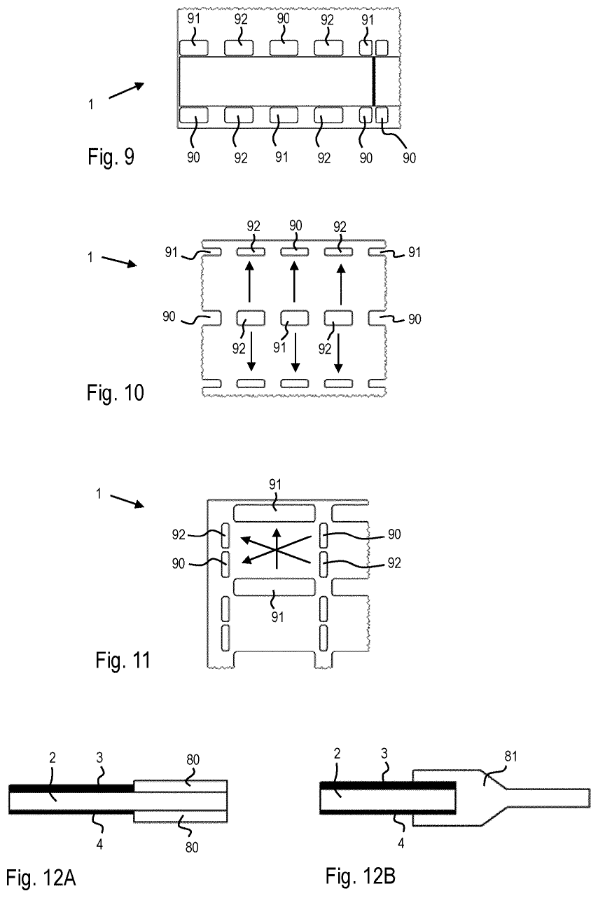

FIG. 9 shows a partial schematic top view of a fourth embodiment of a fuel cell according to the invention. The manifolds 90,91,92 lead the gases in specified directions and limit the gas flows at the edges of the cell using sealants. However, each CCM can be split into several smaller sections using additional blocking channels that are made of the bipolar plate structure or of special resin, or that are integrated in the sub-gasket.

FIG. 10 shows a partial schematic top view of a fifth embodiment of a fuel cell according to the invention. The gas manifolds 90,91,92 can have any shape like round, oval, square or rectangular; in case of rectangular manifold as shown in FIG. 10, the ratio M/N (manifold length/manifold width) varies between 0.01 and 10 but not limited. Furthermore, the width of the gas manifolds is not necessarily identical, and it can be tuned based on the design. However, it is recommended to keep a constant pattern for all the segments. Another possible option is to have larger manifold for the inlet and smaller for the outlet or vice-versa. In this case, it is assumed that the respective inlet manifold 90,91,92 is in between two adjacent segments and that the outlets are smaller than the inlet or vice-versa. Dimensioning of the manifolds depends on size of the cell and number of segments that divides the cell, and those skilled in the art can make necessary calculation and design in order to dimension the manifolds properly based on their expectations.

FIG. 11 shows a partial schematic top view of a sixth embodiment of a fuel cell according to the invention. In this embodiment, the fuel manifolds 90 and the coolant manifolds 92 are moved towards the sides of each segment and repeated throughout the whole cell. The depicted design is a cross-flow configuration, i.e. the flow direction of the fuel is essentially perpendicular to the flow direction the oxidant. With a respective design of the flow field channels, the cross-flow configuration can be converted to a co-flow or a counter-flow configuration. The cathode inlet and outlet manifolds are extended to have more rectangular shape at the top and bottom of each segment. Like previous configurations, inlet or outlet manifolds can be shared between segments or not. Furthermore, manifolds from only one stream can be moved to the sides. For instance, the cooling manifolds can be located at the left and right side of each segment and the manifolds for the cathode and fuel positioned side by side at the top and bottom of each segment. The dimensions of the active area and therefore the CCM are also not limited for any embodiment. The active area preferably can have a square, rectangular or any other shape but recommended square or rectangular. In case of rectangular layout, the ratio CL/CW (CCM length/CCM width) varies between 0.01 and 100 but not limited.

FIG. 12A shows a schematic cross-section of a first embodiment of a sub-gasket and FIG. 12B shows a schematic cross-section of a second embodiment of a sub-gasket. There are a few standard techniques for manufacturing Membrane Electrode Assembly (MEA) for a PEM fuel cell, which will not be explained here. However, any design can be implemented in production of a cell based on current innovation. There is no limitation on thickness and material used on the catalyst coated membrane (CCM), the gas diffusion layer (GDL) and the frame/sub-gasket around the CCM. For instance, the sub-gasket can be made of various thermoplastics such as PTFE, PET, PEN or resins and it could also include sealing materials on either side. In the embodiment of FIG. 12A, the membrane is extended further and there is overlapping only between the membrane and the sub-gaskets and not the catalysts. The embodiment of the sub-gasket of FIG. 12B shows an overlapping between the frame/sub-gasket and the CCM, it means the membrane and catalyst layers are sandwiched by the sub-gasket. The sub-gaskets can be attached to the membrane or the CCM using different methods such as lamination, gluing or fusing but not limited. These are just for demonstration and any other configuration or approach can be used. Another possibility is to have the sealing directly on the CCM or the membrane.

### REFERENCE SIGNS LIST

| | | | |
|---|---|---|---|
| 1 | fuel cell | 70 | spacer |
| 2 | membrane | 71 | connection channel |
| 3 | anode electrode layer | 72 | flow field channel |
| 4 | cathode electrode layer | 73 | cooling channel |
| 5 | gas diffusion layer | 8 | gasket |
| 6 | first flow field structure | 80 | sub-gasket |
| 60 | spacer | 81 | sub-gasket |
| 61 | connection channel | 90 | fuel manifold |
| 62 | flow field channel | 91 | oxidant manifold |
| 63 | cooling channel | 92 | coolant manifold |
| 7 | second flow field structure | A(ij) | active area |
| | | S(ij) | segment |

What is claimed is:

1. A fuel cell (1) comprising at least one membrane (2), at least one anode electrode layer (3), at least one cathode electrode layer (4), at least two gas diffusion layers (5) and at least two flow field structures (6;7), wherein the at least one membrane (2) is arranged between one anode electrode layer (3) and one cathode electrode layer (4), forming a membrane electrode assembly and defining an active area (Aij), wherein one gas diffusion layer (5) is arranged adjacent to each electrode layer (3;4) and wherein one flow field structure (6;7) is arranged adjacent to each gas diffusion layer (5), wherein each flow field structure (6;7) comprises at least three fuel manifolds (90), at least three oxidant manifolds (91) and at least three coolant manifolds (92), characterized in that the fuel cell (1) comprises at least two active areas (A11;A12) and in that at least one fuel manifold (90), at least one oxidant manifold (91) and at least one coolant manifold (92) is arranged between the at least two active areas (A11;A12).

2. The fuel cell (1) according to claim 1, wherein at least one of each of the three manifolds (90;91;92) is an inlet manifold and at least two are outlet manifolds or wherein at least two of the three manifolds (90;91;92) are inlet manifolds and at least one is an outlet manifold.

3. The fuel cell (1) according to claim 2, wherein the number of outlet manifolds is twice the number of inlet manifolds or wherein the number of inlet manifolds is twice the number of outlet manifolds.

4. The fuel cell (1) according to claim 1, wherein the cross-sectional size of all manifolds (90;91;92) is identical or wherein the cross-sectional size of at least one of the manifolds (90;91;92) differs from the size of the other manifolds.

5. The fuel cell (1) according to claim 1, wherein the cross-sectional shape of all manifolds (90;91;92) is identical or wherein the cross-sectional shape of at least one of the manifolds differs from the shape of the other manifolds.

6. The fuel cell (1) according to claim 5, wherein the shape of the manifolds (90;91;92) is one of the group comprising angled, rectangular, square, oval and round.

7. The fuel cell (1) according to claim 2, wherein for each of the three manifolds (90;91;92), the total cross-sectional area of all inlet manifolds equals the total cross-sectional area of all outlet manifolds.

8. The fuel cell (1) according to claim 2, wherein for each of the three manifolds (90;91;92), the total cross-sectional area of all inlet manifolds is larger than the total cross-sectional area of all outlet manifolds or wherein for each of the three manifolds (90;91;92), the total cross-sectional area of all inlet manifolds is smaller than the total cross-sectional area of all outlet manifolds.

9. The fuel cell (1) according to claim 2, wherein the total cross-sectional area of the fuel manifolds (90) equals the total cross-sectional area of the oxidant manifolds (91) and/or the total cross-sectional area of the coolant manifolds (92).

10. The fuel cell (1) according to claim 2, wherein the total cross-sectional area of the fuel manifolds (90) is larger than the total cross-sectional area of the oxidant manifolds (91) and/or the total cross-sectional area of the coolant manifolds (92) or wherein the total cross-sectional area of the fuel manifolds (90) is smaller than the total cross-sectional area of the oxidant manifolds (91) and/or the total cross-sectional area of the coolant manifolds (92).

11. The fuel cell (1) according to claim 1, comprising a pattern of manifolds (90;91;92) that repeats itself in at least a first direction (X) or that repeats itself in the first direction (X) and in a second direction (Y), perpendicular to the first direction (X).

12. The fuel cell (1) according to claim 1, wherein the distance between two repeating patterns is identical to the distance between two neighbouring manifolds (90;91,92) within the patterns or wherein the distance between two repeating patterns is bigger than the distance between two neighbouring manifolds (90;91;92) within the patterns.

13. The fuel cell (1) according to claim 1, comprising at least two gaskets (8), wherein one gasket (8) is arranged adjacent to each flow field structure (6;7) and wherein each gasket (8) comprises the same number of manifolds (90;91;92) as the flow field structures (6;7) at the same positions.

14. The fuel cell (1) according to claim 1, comprising at least one sub-gasket (80;81), wherein the sub-gasket (80;81) covers at least border areas of the membrane (2) on both sides or wherein the sub-gasket (80;81) covers at least border areas on areas of the membrane (2) and the electrode layers (3;4) on both sides.

15. The fuel cell (1) according to claim 14, wherein the sub-gasket (81) extends laterally over the border areas of the membrane (2) and the electrode layers (3;4).

16. The fuel cell (1) according to claim 1, comprising several membrane electrode assemblies, several gas diffusion layers (5) and several flow field structures (6;7) that are aligned with each other and are forming a stack.

17. The fuel cell (1) according to claim 1, comprising two current collector plates and two backing plates, wherein one collector plate is arranged adjacent to each flow field structure (6;7) and wherein one backing plate is arranged adjacent to each collector plate.

18. The fuel cell (1) according to claim 17, comprising clamping elements bracing the two backing plates.
